(19) United States
(12) Patent Application Publication
(10) Pub. No.: US 2015/0254725 A1
(43) Pub. Date: Sep. 10, 2015

(54) Method and System for Providing User Information on Online Service

(71) Applicant: Korean Advanced Institute of Science and Technology, Daejeon (KR)

(72) Inventors: Jun Kyun Choi, Daejeon (KR); Jin Hong Yang, Daejeon (KR); Hyo Jin Park, Daejeon (KR)

(73) Assignee: Korean Advanced Institute of Science and Technology, Daejeon (KR)

(21) Appl. No.: 14/500,611

(22) Filed: Sep. 29, 2014

(30) Foreign Application Priority Data
Mar. 10, 2014 (KR) 10-2014-0027589

(51) Int. Cl. G06Q 30/02; G06F 17/30

(52) U.S. Cl. CPC G06Q 30/0269; G06F 17/30386

(57) ABSTRACT

A method and system for providing user information on an online service is disclosed. A content providing method configured as a computer may include setting a providing range of information associated with a user using an online service for each online service, matching an open application program interface (API) of the online service with respect to the providing range of information associated with the user, and providing content corresponding to the providing range of information associated with the user through the online service in interaction with the open API.

### CROSS-REFERENCE TO RELATED APPLICATION

This application claims the priority benefit of Korean Patent Application No. 10-2014-0027589, filed on Mar. 10, 2014, in the Korean Intellectual Property Office, the disclosure of which is incorporated herein by reference.

### BACKGROUND

1. Field of the Invention

Embodiments of the present invention relate to a content providing method and system that may provide content associated with user information.

2. Description of the Related Art

Online users are using a plurality of social services and web services. In particular, with the distribution of portable terminals such as smartphones, tablets, and laptops, users are further exposing information, such as their social commerce and behaviors including healthcare, online using a more number of individual services.

Many service providers used by users provide advertisements by gathering and analyzing activity information of a user within an individual service in return for providing the service, and thereby guarantee and create profits through the advertisements.

For example, Korean Patent Publication No. 10-2013-0100841, published on Sep. 12, 2013, entitled “apparatus and method for deciding target advertising using interest information of user” discloses technology for gathering documents created by a user in association with a document of another user, a community joined by the user, and neighbor information of the user, and determining a target advertisement optimized for a target corresponding to an interest of the user based on the collected information.

Individual providers are collecting user information specialized for a corresponding service and are using the collected information for advertisements and the like. However, user information is limited and efforts are being made to gather extensive user activity information through an account connection such as a social graph. However, efforts using such a social graph refer to a business model based on a platform subscriber and are dependent on a predetermined service. In particular, there are some constraints in collecting all characteristics of teenagers and twenties that quickly migrate services. Also, each individual service provides different user information and thus, can collect only macroscopic information.

An advertisement executor may execute an advertisement based on only fragmentized use information of a user and thus, may raise a complaint about a relatively low advertising effect compared to execution costs. In particular, in the case of executing an advertisement on online multimedia, a duplication of the advertisement execution may occur. A method of providing a service using a user tracing scheme is currently on service in a form of providing a cookie on a browser, however, is limited due to spread of a private browsing pattern.

A user may not verify explicit information regarding to which extent information of the user has been used for advertisement information of a corresponding company, and does not receive a separate reward in addition to a free use of a service. Although the user encounters and consumes many advertisements through individual services, the user may not readily acquire desired information. Further, since each individual service uses a different advertisement execution style, the user may be confused in making a selection. In addition, the user may not explicitly verify whether personal information is leaked.

### SUMMARY

An aspect of the present invention provides a content providing method and system that may collect user information from individual services online and may use only explicit information of which a use is agreed by a user.

An aspect of the present invention also provides a content providing method and system that may explicitly manage user information by requesting, processing, and then discarding user data, instead of separately storing the user data.

According to an embodiment of the present invention, there is provided a content providing method configured as a computer, the method including:setting a providing range of information associated with a user using an online service for each online service; matching an open application program interface (API) of the online service with respect to the providing range of information associated with the user; and providing content corresponding to the providing range of information associated with the user through the online service in interaction with the open API.

The setting of the providing range of information associated with the user may include exposing an information providing agreement request query for selecting an agreement to provide information associated with the user and the providing range when creating predetermined content on the online service.

The setting of the providing range of information associated with the user may include exposing an information providing agreement request query for selecting an agreement to provide information associated with the user and the providing range, in a banner form on the online service.

The setting of the providing range of information associated with the user may include storing information associated with the user in a catalog form.

The matching of the open API of the online service may include mapping information associated with the open API of the online service and catalog information of the online service.

The matching of the open API of the online service may include registering an open API use condition corresponding to the providing range of information associated with the user with respect to the online service.

The content providing method may further include registering the content provided from a content provider prior to providing the content to the online service.

The registering of the content may include setting an exposing condition of the content with respect to predetermined data on a data catalog selected by the content provider.

The providing of the content may include providing a notification indicating a use of information associated with the user on the content prior to providing the content to the online service.

The providing of the content may include determining the online service on which the content is to be exposed based on an exposing condition determined for the content.

The providing of the content may include classifying a type of the open AP and providing the content in a polling type or a push type.

According to another aspect of the present invention, there is provided a content providing system including:a memory in which at least one program is loaded; and at least one processor. According to a control of the program, the at least one processor may process:a process of setting a providing range of information associated with a user using an online service for each online service; a process of matching an open API of the online service with respect to the providing range of information associated with the user; and a process of providing content corresponding to the providing range of information associated with the user through the online service in interaction with the open API.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of a data brokering system for providing content using user information online according to an embodiment of the present invention.

FIG. 2 is a flowchart illustrating a method of providing user information and registering a service according to an embodiment of the present invention.

FIG. 3 is a flowchart illustrating a method of providing a notification in response to an agreement to use information when creating content of a user according to an embodiment of the present invention.

FIG. 4 is a flowchart illustrating a method of managing basic user information according to an embodiment of the present invention.

FIG. 5 is a flowchart illustrating a method of providing, by content providers, contents based on a data catalog according to an embodiment of the present invention.

FIG. 6 is a flowchart illustrating a method of providing content to an individual service of a user according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Hereinafter, embodiments of the present invention will be described with reference to the accompanying drawings.

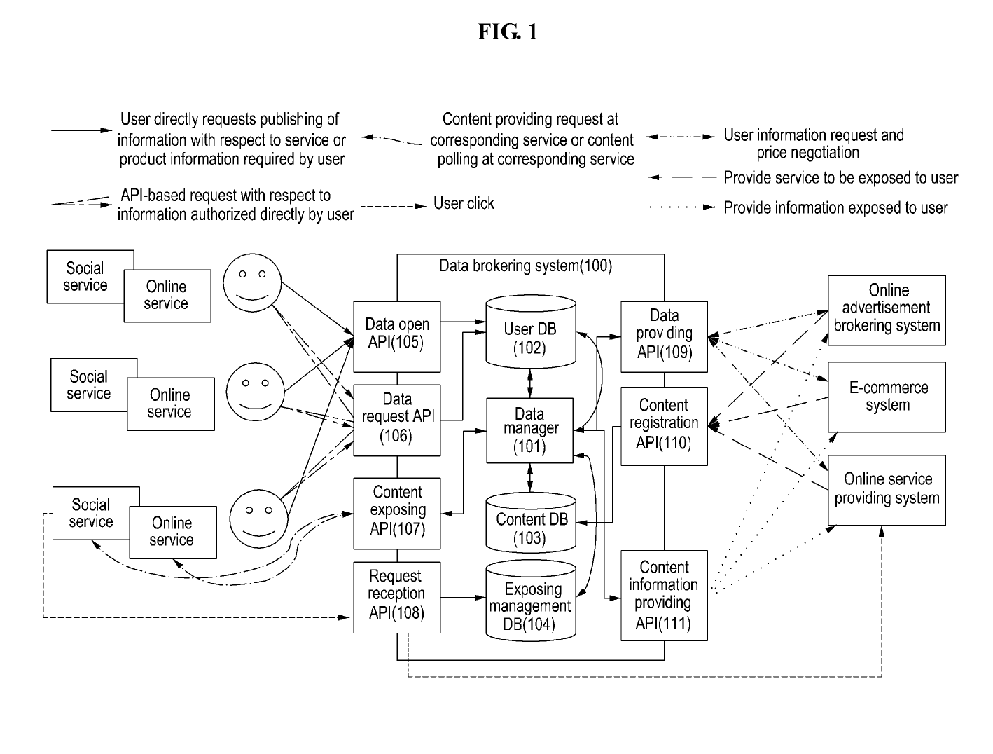

FIG. 1 is a block diagram illustrating a configuration of a data brokering system 100 for providing content using user information online according to an embodiment of the present invention.

Referring to FIG. 1, the data brokering system 100 may include a data manager 101, a user database (DB) 102, a content DB 103, an exposing management DB 104, a data open application protocol interface (API) 105, a data request API 106, a content exposing API 107, a request reception API 108, a data providing API 109, a content registration API 110, and a content information providing API 111.

The data manager 101 may provide an information update function of an individual service being used by a user and a catalog creation function. Also, the data manager 101 may provide content registering function of a content provider and exposing information management function. Also, when providing connected information of an individual service for each user, the data manager 101 may provide a function of analyzing the information and updating a self-catalog. That is, when users are registering individually using services, information update and service providing coverage may be continuously expanded. Since a purpose or a type of a service provided for each individual service may differ, catalog information may be managed in an ontology form with respect to a related keyword. When a user uses a plurality of services, a maximum content exposing effect may be secured by separately managing information for each user. The data manager 101 may statistically manage and provide use counts of user information, for example, a data request, and exposing information thereof in response to a request of a user. For example, the data manager 101 may provide statistical information about the use counts of user information or exposing information thereof to the user through a data open portal or an e-mail.

The user DB 102 serves to store and maintain service account information for each user and a description related to an agreement to publish user information on an individual service. Here, the user DB 102 includes the following field information; (1) information, for example, an Oauth account and API information such as an address and a key, for authenticating an individual service and (2) user information, for example, an e-mail address, a password, and information, for example, an authentication date and an authentication range, associated with an agreement to provide information for each service.

The content DB 103 may provide a function of storing, in a catalog form, available information for each individual user and service that is created by the data manager 101. Also, the content provider 103 may provide a function of storing contents provided from content providers. Here, contents of the content providers may be directly uploaded and provided, or may be connected through a uniform resource locator (URL).

The exposing management DB 104 may provide a function of recording information exposed on an actual service.

The data open API 105 may refer to a site and an API that enable a user and service providers to directly provide information of the user and the service providers. Here, the data open API 105 may request explicit information about access counts to individual content.

The data request API 106 serves as an interface of reading related data based on information authorized by a user with respect to an individual service. Here, the data request API 106 requests data about an individual service each time, instead of crawling data about the individual service. The data request API 106 is provided in a configuration in which an explicit information request is allowed by limiting the number of API requests and the range of API request based on a description related to an agreement to publish user information. The user may verify information about explicit use counts of information of the user by verifying API use information at a using service and by comparing the verified API use information and use information on the data brokering system 100.

The content exposing API 107 serves as an interface of exposing registered content based on a user agreement, and may be divided into a polling t type and a push type based on a content providing method. Here, the content exposing API 107 may provide a service in response to a request from an individual service based on information registered by the user, instead of using a direct request or a push from the data brokering system 100. Also, when the user uses a predetermined service through 3^{rd} party applications (Apps), the content exposing API 107 may provide content in association with information of a 3^{rd} party service provider.

The request reception API 108 may provide a function of receiving and logging corresponding content or corresponding service information in response to exposing content on an individual service or in response to a request for service information through a click on the corresponding content.

The data providing API 109 serves as an interface of providing a service provided from the data brokering system 100 and brief user information.

The content registration API 110 serves as an interface of registering content to be exposed for a user. Here, content to be exposed may also be referred to as exposing content.

The content information providing API 111 serves as an interface of providing information of content to be exposed for a user.

According to the configuration as above, the data brokering system 100 may manage information of which publication is explicitly agreed by a user for each individual service and may provide related content based on an agreement to publish user information.

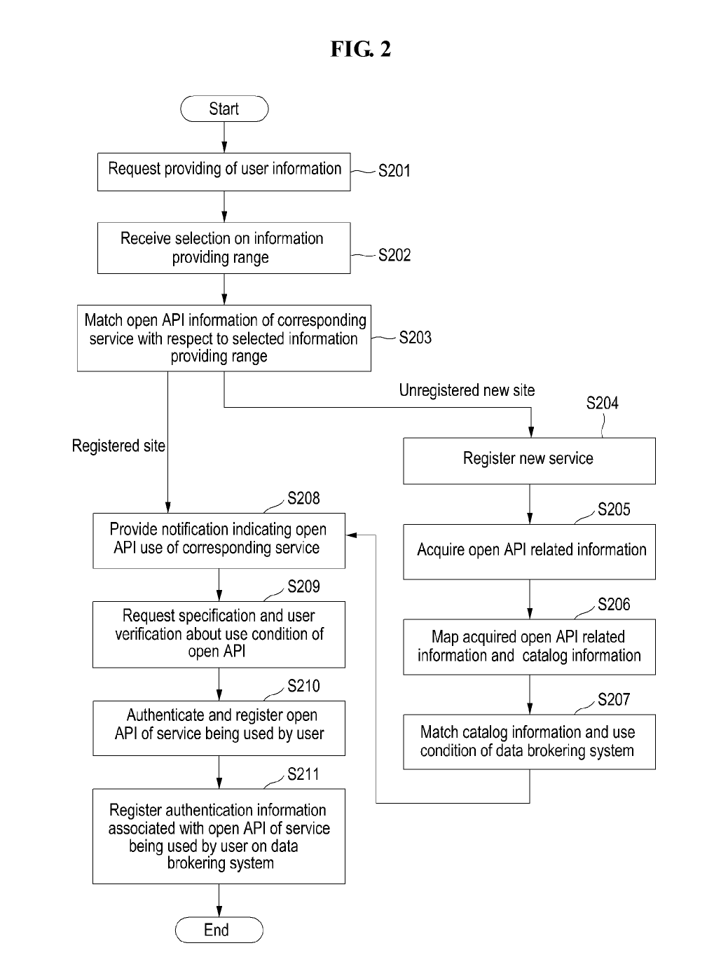

FIG. 2 is a flowchart illustrating a method of providing user information and registering a service according to an embodiment of the present invention. Operations included in the method of providing user information and registering a service according to an embodiment may be performed by a data brokering system described above with reference to FIG. 1.

In operation S201, the data brokering system may request providing of user information for each individual service used by a user. As an example, as a method of requesting providing of user information, the user may directly transfer an agreement to provide information of the user through an authentication on a service of the data brokering system. As another example, the data brokering system may acquire the user agreement to provide information by exposing an information providing request query when creating content such as uploading a predetermined post or a photo on an individual service used by the user. As another example, the data brokering system may acquire the user agreement to provide information directly from a corresponding service by exposing an information providing request query in a form of an advertisement banner on an individual service.

In operation S202, the data brokering system may receive a selection on an information providing range from the user when the user agrees to provide information.

In operation S203, the data brokering system may match open API information of the corresponding individual service with respect to the information providing range selected by the user.

In operations S204 and S205, when a corresponding individual service is an unregistered new site, the data brokering system may register the individual service as a new service and may acquire open API related information.

In operation S206, the data brokering system may map the open API related information acquired from the new service and catalog information of the corresponding service. As an example, the data brokering system may map open API related information and catalog information through a character string comparison between an open API uniform resource locator (URL) and a description. As another example, when registered to an external service, for example, “programmableweb.com”, the data brokering system may perform mapping using catalog information of the corresponding service.

In operation S207, the data brokering system may match catalog information and a use condition of the data brokering system with respect to the individual service registered as the new service.

In operations S208 and S209, the data brokering system may provide a notification indicating an open API use of a corresponding service with respect to the registered individual service or the individual service that matches the use condition of the data brokering system and accordingly, may request a specification and a user verification about the use condition of the open API. Here, the use condition of the open API use may be set to be accessible using only information such as the number of times designated by the user, a data amount, or a predetermined date, instead of being available at any time in interaction with the open API. Such a function may not be provided from an existing service provider, for example, an online service or a social network service (SNS), used by the user, and may be provided from the data brokering system based on corresponding setting information.

In operations S210 and S211, the data brokering system may register authentication information associated with the open API of the individual service on the data brokering system by authenticating and registering the open API of the individual service being used by the user.

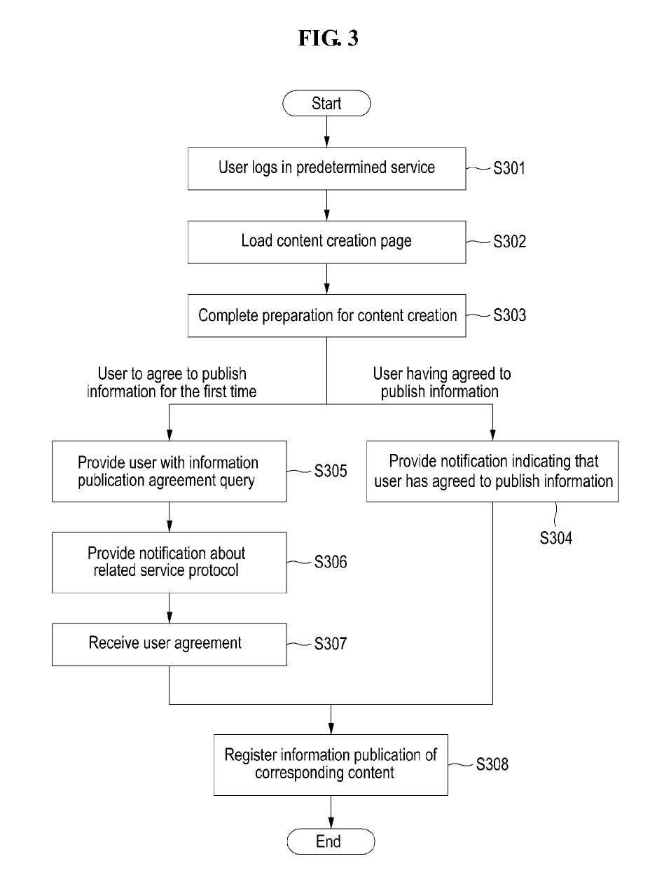

FIG. 3 is a flowchart illustrating a method of providing a notification in response to an agreement to use information when creating content of a user according to an embodiment of the present invention. Operations included in the notification providing method according to an embodiment may be performed by a data brokering system described above with reference to FIG. 1.

In operations S301 and S302, the data brokering system may load a content creation page to a user in response to a login of the user into a predetermined service.

In operation S303, in response to a completion in a preparation for content creation, the data brokering system determines whether the user is a user to agree to publish information for the first time or a user having agreed to publish information.

In operation S304, when the user has agreed to publish information, the data brokering system may provide a notification indicating that the user has agreed to publish information. Here, when the user explicitly specifies that the user agrees to publish content related information through an open API, a notification indicating that it is possible to publish the corresponding content may be provided. The corresponding information may be exposed when creating related content for the first time after the user has agreed to publish information.

In operations S305 and S306, when the user is to agree to publish information for the first time, the data brokering system may provide the user with an information publication agreement query and a notification about a related service protocol. Here, the information publication agreement query is a message for asking the user about whether the user agrees to publish information. Aside from a case in which the user directly publishes information using a data open portal of the data brokering system, the information publication agreement query may be provided when a service provider of an individual service being used by the user is to ask the user about whether the user agrees to use information with respect to content directly created by the service provider in order to explicitly provide user information on the data brokering system.

In operation S307, the data brokering system may receive a user intent regarding whether the user agrees to publish information with respect to the corresponding content through the information publication agreement query.

In operation S308, the data brokering system may register information publication of the content for which the user has agreed to publish information.

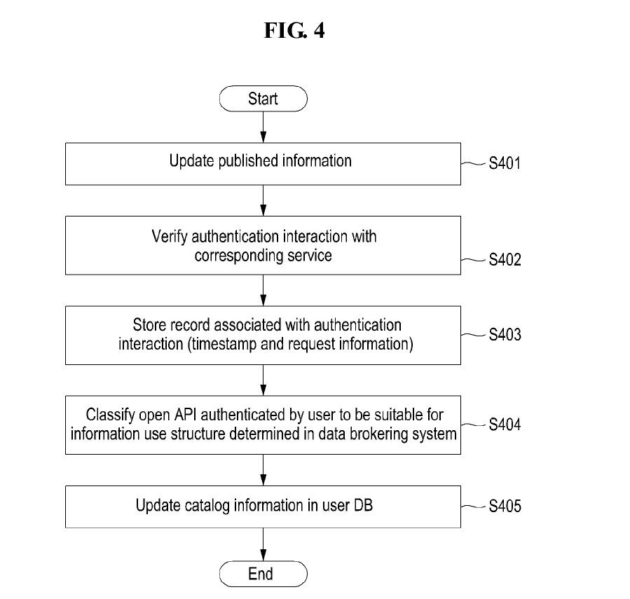

FIG. 4 is a flowchart illustrating a method of managing basic user information according to an embodiment of the present invention. Operations included in the method of managing basic user information according to an embodiment may be performed by the data brokering system described above with reference to FIG. 1.

In operation S401, the data brokering system may update published information with respect to an individual service being used by a user.

In operations S402 and S403, the data brokering system may verify an authentication interaction with the individual service and may store a record, for example, an authentication timestamp and request information, associated with the authentication interaction.

In operations S404 and S405, the data brokering system may classify an open API authenticated by the user to be suitable for an internally determined information use structure and accordingly, may update catalog information of the user stored in a user DB. Information capable of being provided in a form of the open API is present in a form different from an existing advertisement catalog. For example, a catalog may be provided in a configuration in which behavior information of the user is extractable from the individual service as expressed by Table 1. For example, the catalog may be configured using a message, a photo, a position, dialog content, and a review. When a new service is added and a new service type appears, new catalog information may be updated.

TABLE 1

| No | Catalog Info | Catalog Description |
|---|---|---|
| 1 | Achievement-id | An achievement created by a Game |
| 2 | Album-id | A photo album. |
| 3 | Application-id | A app. on it's platform |
| 4 | Checkin-id | A single visit to a position |
| 5 | Comment-id | A Comment published on any other node |
| 6 | Domain-id | A web domain claimed within it's service |
| 7 | Link-id | A link shared on it's service |
| 8 | Message-id | A message |
| 9 | Object-id | A set of likes on a particular object |
| 10 | Offer-id | An offer published by a page |
| 11 | Payment-id | Details of a payment made via it's service |
| 12 | Photo-id | A photo published to it's service |
| 13 | Post-id | A post published to it's service |
| 14 | Review-id | A review of a it's app |
| 15 | User-id | A person using it's service |
| 16 | Video-id | A video published to it's service |

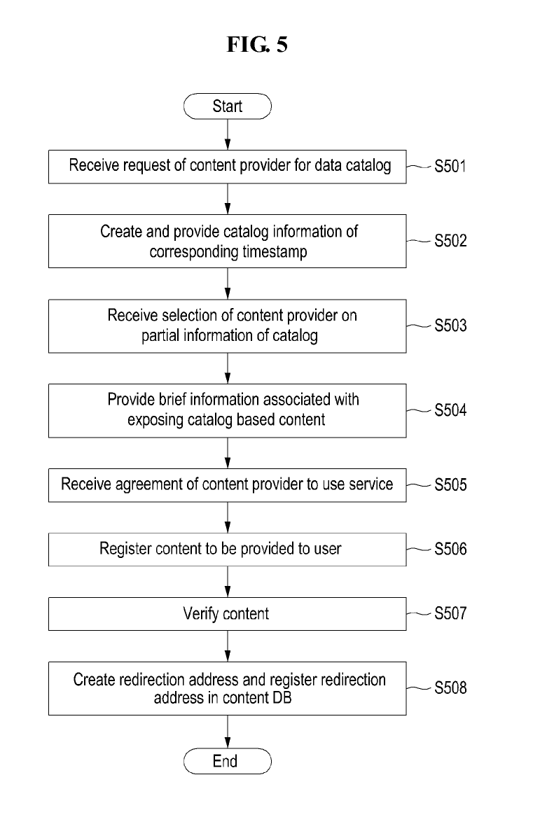

FIG. 5 is a flowchart illustrating a method of providing, by content providers, contents based on a data catalog according to an embodiment of the present invention. Operations included in the content providing method according to an embodiment may be performed by a data brokering system described above with reference to FIG. 1.

In operations S501 and S502, the data brokering system may create and provide catalog information of a corresponding timestamp in response to a request of a content provider for a data catalog.

In operations S503 and S504, the data brokering system may provide brief information associated with exposing catalog-based content, that is, brief information available on a catalog when the content provider selects partial information on the catalog. The data brokering system may provide brief information regarding whether the content provider is allowed to use information such as a target service available to the content provider when a content provider provides exposing content about data on a predetermined catalog, a position and a type of exposing content within the target service, for example, an image, a writing, and a popup, customer group information, for example, a position, an age, and a access frequency, and a customer pattern.

In operations S505 and S506, the data brokering system may register content to be provided to the user when the service provider agrees to use a service.

In operations S507, the data brokering system may verify the content registered by the content provider. Here, the data brokering system may verify the registered content based on user age information, a service signup condition, and the like.

In operation S508, the data brokering system may create a redirection address of the content of which the verification is completed, and may register the created redirection address in a content DB.

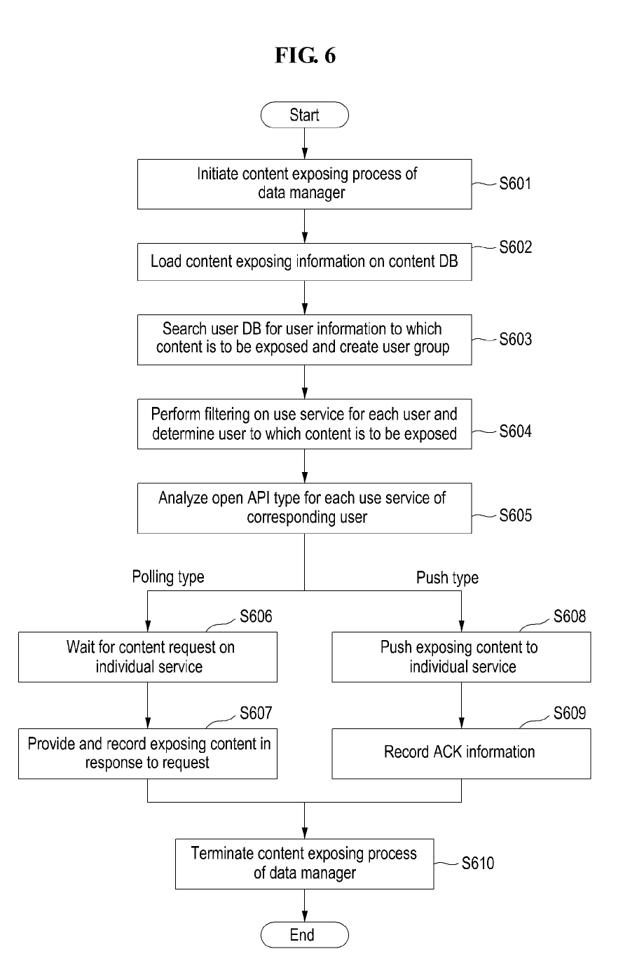

FIG. 6 is a flowchart illustrating a method of providing content to an individual service of a user according to an embodiment of the present invention. Operations included in the content providing method according to an embodiment may be performed by a data brokering system described above with reference to FIG. 1.

In operation S601, the data brokering system initiates a content exposing process. Here, a data manager of the data brokering system may periodically execute a process for exposing content.

In operation S602, the data brokering system may load content exposing information on a content DB.

In operation S603, the data brokering system may search a user DB for user information to which the content is to be exposed, and may create a user group.

In operation S604, the data brokering system may perform filtering on an individual service for each user and may determine a user to which the content is to be exposed. The data brokering system may provide a variety of filtering functions based on a content exposing type desired by the content provider. For example, the data brokering system may set filtering criteria or information, such as a disallowance of duplicate exposing within the same service, a disallowance of duplicate exposing for each service with respect to the same user, a setting of exposing content information, an exposing interval, a timeline, and a position.

In operation S605, the data brokering system may analyze an open API type for each individual service used by the user to which the content is to be exposed.

In operation S606 and S607, when the open API of the individual service is provided in a polling type, the data brokering system may wait for a content request on the individual service and may provide and record the exposing content in response to the content request.

In operations S608 and S609, when the open API of the individual service is provided in a push type, the data brokering system may push the exposing content to the individual service and may record acknowledgement (ACK) information.

In operation S610, the data brokering system provides the content to the individual service and terminates the content exposing process of the data manager.

The methods according to embodiments of the present invention may be configured in a program instruction form executable through a variety of computer systems, and may be recorded in non-transitory computer-readable media.

As described above, according to embodiments of the present invention, a user may explicitly publish only information of the user and may be provided with related contents, in addition to a content recommendation and advertisement service provided from an individual service used by the user. For example, the user may expose photo information using Instagram and Facebook, and may use a service for exposing and recommending content service in a form in which only related information is collected. An explicit information request may be allowed by limiting the number of API requests and the range of API request based on a description of user agreement information. The user may verify information about explicit use counts of information of the user by verifying API use information at a using service and by comparing the verified API use information and use information on a data brokering system.

According to embodiments of the present invention, a service provider may secure additional benefits through the appearance of an additional content provider at a site of the service provider. Since relationships such as “service provider ƒ→ data brokering system ƒ→ content provider” are established, the service provider may create benefits with the appearance of a new content provider.

According to embodiments of the present invention, a 3^{rd} party service App provider may perform an advertisement execution using user information by requesting a publication of user information. For example, Twitter corresponding to the 3^{rd} party App provider may receive an agreement to publish user information from the user and then may create an advertisement inventory by connecting information substantially uploaded to Twitter to a data brokering system.

According to embodiments of the present invention, a content provider may provide an advertisement by concentrating the advertisement, which has been executed through distribution to an individual service, on a service use pattern of an individual user and related content, and may secure a further enhanced advertisement exposing effect by increasing a hit rate of the advertisement.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A content providing method configured as a computer, the method comprising:
setting a providing range of information associated with a user using an online service for each online service;
matching an open application program interface (API) of the online service with respect to the providing range of information associated with the user; and
providing content corresponding to the providing range of information associated with the user through the online service in interaction with the open API.

2. The method of claim 1, wherein the setting of the providing range of information associated with the user comprises exposing an information providing agreement request query for selecting an agreement to provide information associated with the user and the providing range when creating predetermined content on the online service.

3. The method of claim 1, wherein the setting of the providing range of information associated with the user comprises exposing an information providing agreement request query for selecting an agreement to provide information associated with the user and the providing range, in a banner form on the online service.

4. The method of claim 1, wherein the setting of the providing range of information associated with the user comprises storing information associated with the user in a catalog form.

5. The method of claim 1, wherein the matching of the open API of the online service comprises mapping information associated with the open API of the online service and catalog information of the online service.

6. The method of claim 1, wherein the matching of the open API of the online service comprises registering an open API use condition corresponding to the providing range of information associated with the user with respect to the online service.

7. The method of claim 1, further comprising:
registering the content provided from a content provider prior to providing the content to the online service.

8. The method of claim 7, wherein the registering of the content comprises setting an exposing condition of the content with respect to predetermined data on a data catalog selected by the content provider.

9. The method of claim 1, wherein the providing of the content comprises providing a notification indicating a use of information associated with the user on the content prior to providing the content to the online service.

10. The method of claim 1, wherein the providing of the content comprises determining the online service on which the content is to be exposed based on an exposing condition determined for the content.

11. The method of claim 1, wherein the providing of the content comprises classifying a type of the open AP and providing the content in a polling type or a push type.

12. A content providing system comprising:
a memory in which at least one program is loaded; and
at least one processor,
wherein, according to a control of the program, the at least one processor is configured to process:
a process of setting a providing range of information associated with a user using an online service for each online service;
a process of matching an open application program interface (API) of the online service with respect to the providing range of information associated with the user; and
a process of providing content corresponding to the providing range of information associated with the user through the online service in interaction with the open API.
